(19) United States
(12) Patent Application Publication
(10) Pub. No.: US 2013/0073324 A1
(43) Pub. Date: Mar. 21, 2013

(54) Systems and Methods For Booking Live Shows

(71) Applicant: Addison Kang Liu, Los Angeles, CA (US)

(72) Inventor: Addison Kang Liu, Los Angeles, CA (US)

(73) Assignee: Resilient LLC, Los Angeles, CA (US)

(21) Appl. No.: 13/622,903

(22) Filed: Sep. 19, 2012

Related U.S. Application Data
(60) Provisional application No. 61/536,511, filed on Sep. 19, 2011.

(51) Int. Cl. G06Q 10/02

(52) U.S. Cl. 705/5

(57) ABSTRACT

Systems and methods in accordance with embodiments of the invention enable coordinated booking of live shows among artists, fans and venues. One embodiment includes a coordination server configured to: query for standards required for performance; query for pre buy tickets, where a pre buy ticket indicates that a certain amount of funds have been allocated for charge for the purchase of a ticket to experience a performance by an artist after the artist is booked at a venue; determine whether the standards are met based upon the amount of funds allocated by pre buy tickets; query for bids by venues after the standards are met, where a bid is an offer by a venue for the artist to perform at the venue; and book the artist at a winning venue, where the winning venue is a venue whose offer is accepted.

### CROSS-REFERENCE TO RELATED APPLICATIONS

This application claims priority to U.S. Provisional Application No. 61/536511 filed Sep. 19, 2011, titled “SYSTEMS AND METHODS FOR BOOKING LIVE SHOWS”, the disclosure of which is incorporated herein by reference in its entirety.

### FIELD OF THE INVENTION

The present invention relates generally to booking live shows and more specifically to systems and methods for booking live shows by coordinating between artists, fans and venues.

### BACKGROUND OF THE INVENTION

A live show typically includes artists performing a show to fans at a venue. Artists can include any person who showcases a product or a skill, such as a musician, actor or artist discussing works of art. Fans can include any person interested in gaining access to a live show, such as followers of an artist or an interested member of the public. Venues can include any place that an artist can perform a show for fans, such as small venues at a coffee shop or a person's home to larger venues at a park or theater attended by thousands of people.

Typically, promoters negotiate a deal to bring an artist and a venue together. This can include selling a show to artists and venue owners based upon profitability information such as past record sales or radio airplay. Fans typically purchase tickets from the venue or from a ticket distribution service such as Ticketmaster Entertainment Inc., based in West Hollywood, Calif. Ticket distribution services can act as a middleman, imposing fees for booking tickets as “convenience fees” on top of the cost of the ticket itself. In certain cases, venues and promoters may be owned by the same entity, such as the case of Live Nation Inc. of Beverley Hills, Calif., which owns a number of venues and owns Ticketmaster Entertainment. An artist typically makes a decision about where and when to tour based upon the artist's management and/or record company associated with the artist.

Historically, resourceful artists can book tours through a booking agent who teams up with a concert promoter to plan out a tour of multiple dates in various cities, teaming up with a pre-established network of venue owners or talent bookers for the venue. The artist (via the artist's management) typically demand an upfront minimum guarantee from concert promoters or venues before the show is confirmed. Venues typically work with the concert promoter to sell tickets and create demand. Venues often have exclusive arrangements with ticket sellers such as Ticketmaster. Marketing for the show is made through traditional media and social media. However, the ticket pricing is set by the concert promoter, venue and/or ticket sellers and the risk of selling tickets is put squarely on the concert promoters or venues. Determination of local demand for an artist is found largely from past concert revenue, the record sales of the artist, radio airplay and the aggregate popularity of the artist based on publicity and media outlets. Bookings can take place without any analysis of real market demand data from actual fans. Bookings for smaller or unknown bands can be difficult as venues cannot gauge demand and are unlikely to devote their resources without knowing that they will be able to sell an adequate number of tickets.

Companies including LiveNation/Ticketmaster Inc. pay artists advances to get exclusive touring rights, forcing artists to perform even to largely empty venues. These actions can sour relationships with fans passionate about music over exorbitant convenience fees, and with artists that want to make their music as accessible to as many of their fans as possible.

### SUMMARY OF THE INVENTION

Systems and methods in accordance with embodiments of the invention enable coordinated booking of live shows among artists, fans and venues. One embodiment includes a system for booking live shows, including: a coordination database configured to store at least one artist account, at least one fan account and at least one venue account; and a coordination server in communication with the coordination database configured to: query at least one artist account for standards that an artist associated with the artist account requires for performance; query at least one fan account for pre buy tickets, where a pre buy ticket indicates that a certain amount of funds have been allocated for charge for the purchase of a ticket to experience a performance by the artist after the artist is booked at a venue; determine whether the standards are met based upon the amount of funds allocated by pre buy tickets; query at least one venue account for bids by venues after the standards are met, where a bid is an offer by a venue for the artist to perform at the venue; and book the artist at a winning venue, where the winning venue is a venue whose offer is accepted.

In a further embodiment, the pre buy tickets are associated with a geographical location for a performance by the artist.

In another embodiment, the standards include an artist's preference for geographic location for performance by the artist.

In a still further embodiment, the standards include a time period for standards to be met within.

In still another embodiment, the standards can be modified to be immediately satisfied.

In a yet further embodiment, the coordination server is configured to query venue accounts within a geographical location that meets the standards.

In yet another embodiment, the coordination database is configured to store an advertiser account and the coordination server is configured to query advertiser accounts for pre buy tickets.

In a further embodiment again, the coordination server is configured to receive the standards from an artist device and store the standards in an artist account.

In another embodiment again, the coordination server is configured to receive bids from a venue device and store the bids in a venue account.

In a further additional embodiment, the standards include at least one criteria selected from the group consisting of geographical location, pre buy ticket quantity and pre buy ticket price range.

In another additional embodiment, the coordination server distributes pre buy ticket revenue between the artist account and the venue account.

In a still yet further embodiment, the coordination server regulates bids by setting at least one criteria by which bids abide selected from the group consisting of frequency of bidding and minimum bidding amount.

In still yet another embodiment, a method for booking live shows, incudes: querying at least one artist account stored on a coordination database using a coordination server in communication with the coordination database for standards that an artist requires for performance; querying at least one fan account stored on the coordination database using the coordination server for pre buy tickets, where a pre buy ticket indicates that a certain amount of funds have been allocated for charge for the purchase of a ticket to experience a performance by the artist after the artist is booked at a venue; determining whether the standards are met based upon the amount of funds allocated by pre buy tickets using the coordination server; querying at least one venue account using the coordination server for bids by venues after the standards are met, where a bid is an offer by a venue for the artist to perform at the venue; and booking the artist using the coordination server at a winning venue, where the winning venue is a venue whose offer is accepted.

In a still further embodiment again, the pre buy tickets are associated with a geographical location for a performance by the artist.

In a still another embodiment again, the standards include an artist's preference for geographic location for performance by the artist.

In a still further additional embodiment, the standards include a time period for standards to be met within.

In still another additional embodiment, the standards can be modified to be immediately satisfied.

In a yet further embodiment again, the coordination server is configured to query venue accounts within a geographical location that meets the standards.

A yet another embodiment again includes querying an advertiser account for pre buy tickets, where the coordination database is configured to store the advertiser account.

In a yet further additional embodiment, the standards include at least one criteria selected from the group consisting of geographical location, pre buy ticket quantity and pre buy ticket price range.

### BRIEF DESCRIPTION OF THE DRAWINGS

FIG. 1 illustrates a system for coordinating between artist devices, fan devices and venue devices in accordance with an embodiment of the invention.

FIG. 2 is a flow chart illustrating a process for a coordination server to book a live show from fan interest, artist standards and venue bids in accordance with an embodiment of the invention.

FIG. 3 is a flow chart illustrating a process for receiving ticket information using a fan device in accordance with an embodiment of the invention.

FIG. 4 is a flow chart illustrating a process for booking a live show using an artist device in accordance with an embodiment of the invention.

FIG. 5 is a flow chart illustrating a process for booking a live show at a venue based on venue capabilities and bidding in accordance with an embodiment of the invention.

FIG. 6 is a flow chart illustrating a process for bidding and coordinating a successfully booked show in accordance with an embodiment of the invention.

FIG. 7 illustrates a home screen user interface on a fan device in accordance with an embodiment of the invention.

FIG. 8 illustrates a user interface for a selected artist on a fan device in accordance with an embodiment of the invention.

FIG. 9 illustrates a system for coordinating between artist devices, fan devices, venue devices and advertiser devices in accordance with an embodiment of the invention.

### DETAILED DESCRIPTION

Turning now to the drawings, systems and methods for coordinated booking of live shows among artists, fans and venues in accordance with embodiments of the invention are shown. In many embodiments, artists interface with artist accounts in a coordination database using artist devices, fans interface with fan accounts in a coordination database using fan devices and venue representatives interface with venue accounts in a coordination database using venue devices. For simplicity, a venue representative can also be referred to as a venue. A coordination server can analyze the database to identify opportunities for artists to play in regions. In addition, venues can use the coordination server to identify artists that want to play in the venue's region and fans can use the coordination server to indicate that they want particular artists to play in their region. A coordination server can make associations in the coordination database that enable certain queries to be performed by artists, venues and fans. A coordination server with a coordination database can coordinate deals directly between artists, fans and venues via communications with artist devices, fan devices and venue devices. A device includes any networkable electronics including computers, cell phones and tablets. An artist using an artist device can first register with a coordination database using a coordination server, and the artist can provide information that is stored in the coordination database concerning the artist's standards for performing at a live show. An artist's standards can include (but are not limited to) geographic locations of interest, ticket volume range, ticket price range, venue type, and time period for a tour or online listing. A fan using a fan device can register a fan with a coordination database using a coordination server and pre buy a ticket for an artist to perform at a fan's desired geographic location. To pre buy a ticket includes temporarily allocating funds sufficient for purchase of a ticket for a fan on behalf of the fan, such as from a credit card, before a ticket is issued but without taking or charging the temporarily allocated funds until the ticket is issued to the fan. In the case where the ticket is not issued to the fan, there is no charge and any funds allocated for the pre buy ticket is returned to the fan. An artist can be committed to play upon satisfaction of the artist standards or if the artist otherwise decides to perform at a specific venue in a geographic location. A venue representative using a venue device can register a venue with a coordination database using a coordination server to publish venue capabilities and bid upon artists performing in the venue's region. A venue that satisfies an artist's standards may bid for the artist to perform at the venue. A coordination server may include a minimum bid value for bidding. An artist can choose among the venue bids to pick where the artist's performance will occur. Once the artist chooses the venue, the chosen (or winning) venue is then notified, pre buy sales proceeds are distributed among the venue and artist, and tickets are distributed to the fans for the booked live event. Tickets can include electronic tickets or tickets distributed via other means including tokens or identification codes that can be redeemed for tickets and/or access to the venue. In many embodiments, a coordination server is configured by machine executable instructions, such as a coordination application, resident within the coordination server.

In numerous embodiments, advertisers interact with artists, fans and venues to influence the booking of an artist to perform at a venue. Advertisers can help fans influence artists to play in the fan's geographic location by pre buying tickets to bring fans closer to satisfying artist standards. Advertisers can directly proposition artists to associate with the advertiser, or for the artist to perform in a venue or a geographic location. Likewise, advertisers can proposition venues to associate with the advertiser before or after a show is booked or to make a venue more attractive to an artist in venue bidding. Fans, artists and venues are also given the option to choose or qualify the advertisers that they deal with as well. Thereby, advertisers are able to generate good will with fans by augmenting a fan's ability to book artists as well as in advertising to targeted demographics and by associating the advertisers with particular artists or venues.

In various embodiments, local collective buying power is combined with social networking for fans to directly book bands to venues in their geographic locality, bypassing traditional concert promoters and ticketing outlets. Attendance to live shows can fuel music discovery via local leaders with influence within their social networks, yielding “power points” to increase status and ranking. These points in turn can be used to redeem real world rewards in the music industry—including the ability to book a local band as the opener for an A-list band or getting to “leak” exclusive songs from major artists. User adoption from fans, artists and venues can spread by an aggregation of large volumes of smaller discrete local networks, creating a large national and global marketplace. By providing incentives to fans to take actions that are aligned with artists' interests, fans will experience personal gain while also demonstrating fan devotion.

In numerous embodiments, lower ticket prices and no service fees are made possible by gauging real-time demand data to ensure that only shows that are guaranteed to sell seats are booked. Certain embodiments of the invention initiate demand first and create a competitive bidding marketplace for suppliers, including venues bidding for a very limited supply of in-demand artists.

Various embodiments include fans targeting artists to play in the fan's desired region. Artists can receive data to provide real-time feedback on their audience demographic; venues can receive concrete data on what artists they should book to pack the venue. Dense urban networks can carry more influence due to the increased volume of users.

In several embodiments, artists or artist representatives will book directly with venue owners or venue representatives via a regulated bidding process using a coordination server. Once qualifying artist and venues enter the bidding process, both parties are incentivized to make a deal as both sides can see that tickets have already been pre-sold and money committed to complete the booking as uncertainty is reduced with respect to gate sales or what the potential audience for a show will be.

In numerous embodiments, venues can set venue capabilities including the type of artists they want to host and the size limitations of the venue or ticket price ranges. Once qualifying thresholds are met, the venue will gain access to the bidding process. From there, the venue can receive the most up to date real time data about pre-sales for the applicable artist. Competing venues can make their best offer to book a show from an artist. Once the artist chooses an offer from a bidding venue, the coordination server can notify the venue owner of a successful bid and distribute a percentage of the pre buy ticket revenue to both the artist and the venue.

Many embodiments facilitate multiple-party business transactions as well as data analytics. Fans can experience a more direct experience with their favorite artist and feel they have direct input in getting their favorite artist to perform for them. Fans not only can support an artist by buying a ticket or an album, but can also have the power to book artists to perform in their local region, city or town. Artists receive real-time data about fan demographics and can use a regulated bidding process to book shows directly with venue owners. Venues receive concrete real-time data about their local customers, their musical likes, and the amount of guaranteed gate revenue from pre bought tickets. In many embodiments, once artist determined standards or thresholds have been met by local fan demand, the regulated bidding process opens for qualifying venues to bid for the artist's services to perform at their venue. Once a deal is reached, revenue from the pre-sold tickets can be split between the artist and the venue, with the operator of the coordination server and database taking a commission from the transaction.

In several embodiments, electronic tickets, or E-tickets can be used to issue tickets. E-tickets can be sent to a fan's, email address or mobile phone and scanned at the venue for entry. In certain embodiments, all tickets can be fully trackable and encourage tickets to be used by the purchaser only. Ticket purchasers who cannot attend a show can be encouraged to sell their tickets to other fans in the network by earning reward points for doing so. This can give an incentive to not sell on to brokers or the secondary market. In particular embodiments with exclusive shows with limited capacity, tickets can be non-transferable and fans unable to attend can have a certain number of hours to notify the coordination server they cannot attend and tickets are thrown back into a general pool. Fans that do not attend and do not notify the system in a timely manner can be penalized, including losing points or forfeiting the value of the ticket.

Although specific processes for booking live shows are discussed above, lives shows can be booked in any manner as appropriate to the requirements of a specific application in accordance with embodiments of the invention. System architectures for booking live shows are discussed below.

### Booking System Architecture

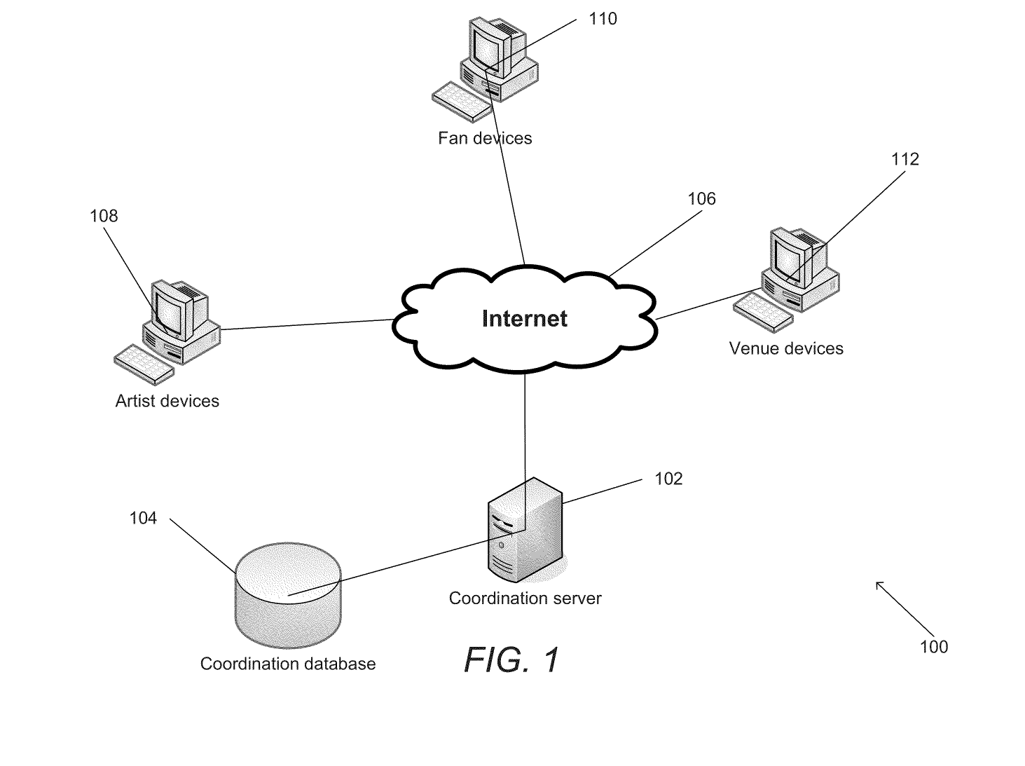

Booking live shows by coordinating between artists, fans and venues using a coordination server and coordination database in accordance with embodiments of the invention can be implemented using many different system architectures. A system 100 for coordinating between artist devices, fan devices and venue devices in accordance with an embodiment of the invention is illustrated in FIG. 1. The system 100 includes a coordination server 102 with a coordination database 104 connected to the Internet 106. Artist devices 108, fan devices 110 and venue devices 112 are also connected to the Internet 106.

In many embodiments, a coordination server coordinates booking between artists using an artist device, fans using a fan device and venues using a venue device. A device includes any networkable electronics or other Internet connected consumer electronic devices including but not limited to Internet connected televisions, set top boxes, Blu-ray/DVD players, computers, cell phones and tablets. These devices enable their users to access and manipulate a coordination database via a coordination server. A coordination server manages, manipulates and analyzes the data within the coordination database. A coordination server can pull additional information off the Internet to supplement the coordination database, such as ratings on venues or artists or other data to enhance a fan's user profile or point distribution. A coordination server can run queries on a coordination database including a determination of fans in a region, fan trends and demand for artists and venue popularity. Artists, fans and venues using their devices thereby manage associated accounts in a coordination database using the coordination server.

Although specific system architectures for booking live shows are discussed above, lives shows can be booked in any manner as appropriate to the requirements of a specific application in accordance with embodiments of the invention. Processes for booking live shows using a coordination server in accordance with embodiments of the invention are discussed further below.

### Processes for Coordinated Booking of Live Shows

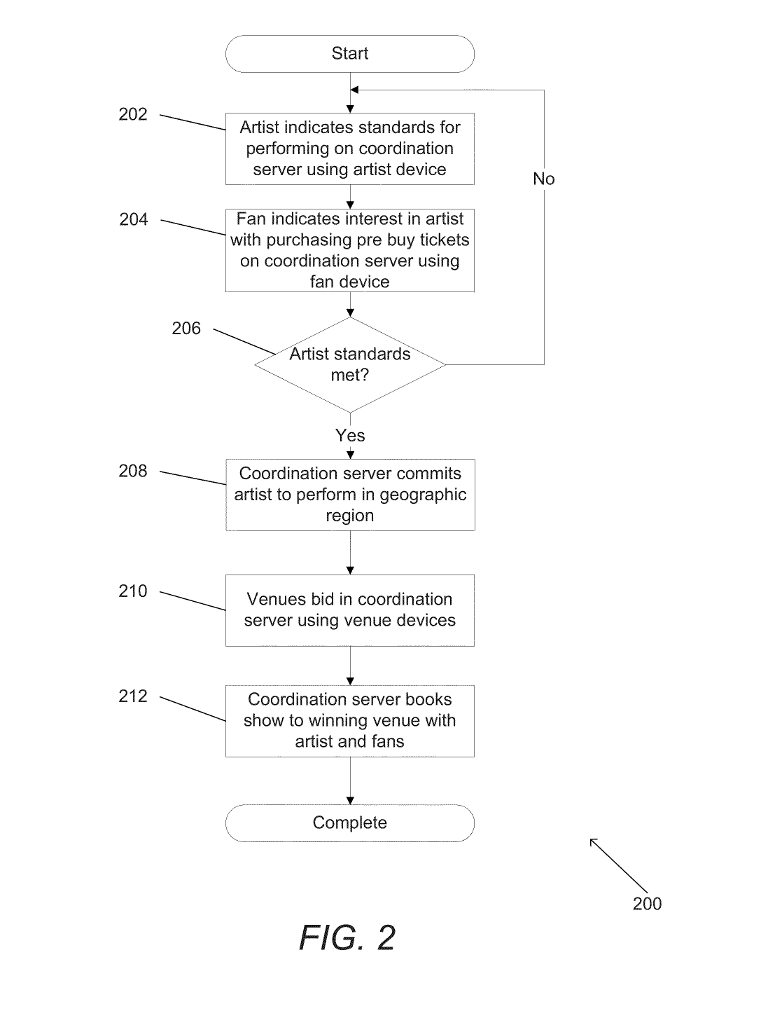

Coordination servers in accordance with many embodiments of the invention can coordinate booking of live shows between artists, fans and venues. A flow chart illustrating a process 200 involving a coordination server coordinating the booking of a live show based upon fan interest, artist standards and venue bids in accordance with an embodiment of the invention is illustrated in FIG. 2. The process 200 includes an artist communicating (202) information indicative of the standard for an artist to perform to a coordination server using an artist device. An artist's standard or standards can include any condition imposed by an artist as a prerequisite for playing or performing in a region. Artist standards are discussed further below. After an indication (202) of artist standards, a fan indicates (204) interest in an artist with purchasing (204) pre buy tickets on a coordination server using a fan device. After purchasing (204) pre buy tickets, a determination (206) is made by the coordination device as to whether the artist standards are met. If the artist standards are not met, then the process loops back to an artist indicating (202) the standard for an artist to perform. If the artist standards are met, then the coordination server commits (208) the artist to choose a bidding venue in the geographic region that satisfies the artist's standards. Venues in the region bid (210) on the artist to perform at their venue on a coordination server using a venue device. After bidding (210), the coordination server books (210) a show to the winning venue, which can be chosen by the artist, with the artist and the fans that have pre buy tickets. After booking the show, the process 200 is complete.

In many embodiments, a fan can indicate interest by pre buying one or more tickets for the artist. A pre buy ticket is one where the fan's credit card is authorized for the ticket amount and only charged if the show is booked. If a ticket is not issued, the fan's credit card is not charged. In a number of embodiments, a finalized ticket purchase and show attendance can also generate an amount of points or rewards back to the fan which can be redeemed for perks including automatic upgrades in ticket status or preferential treatment by a particular artist such as a back stage tour. By pre buying a ticket, a fan is guaranteed participation in an artist performance in the fan's region, an artist is guaranteed a certain amount of fan interest and revenue from the region and a venue is guaranteed a certain amount of fan interest and revenue for booking the artist, all if the artist is booked. Thereby, the artists and venues are incentivized to book a performance given guaranteed fan support.

In several embodiments, an artist can indicate standards for play on a coordination server using an artist device. An artist can choose any number of standards for their performance, including the quantity of fans, type of venues, time period of performance, and financial guarantee. Standards can be pre determined for selection or can be programmed by the artist. Standards may not need to all be met as certain standards may be more important than others. In certain embodiments, all standards must be met.

In various embodiments, a coordination server can perform an analysis of the coordination database to determine whether the standards are met. Artists, fans and venues can manage and modify their accounts in a coordination database, which can then be searched and analyzed to determine if artist standards are met. If artist standards are not met, an artist can revisit and modify the standards or fans can present even more interest in order to meet the artist standards.

In numerous embodiments, a coordination server commits an artist to play in a geographic region once the artist standards are met. Artist standards may be met by satisfying all or only some of the artist's standards, depending on the artist preferences. Artists can also bypass the artist standards and choose to commit to perform in a geographic region despite the lack of satisfied artist standards.

In several embodiments, venues in a region where an artist has committed to play can bid over a coordination server using venue devices for an artist to perform at their venue. A coordination server can regulate the bidding by setting rules for bidding, such as the frequency of bidding, minimum bidding amount and communication between the artists and venues. Bidding is made through venues modifying data stored in a coordination database that is then utilized by a coordination server. Preset bidding may also be implemented by a coordination server, such as setting a winning bid as a bid that best financially rewards the artist. An artist can also manually select a bidding venue as a winning bid dependent upon any factor that the artist chooses.

In many embodiments, a coordination server books a show to a winning venue with the artist and fan's pre buy tickets. Once a winning venue is chosen, the details of booking are determined. A coordination server can then allocate the profits from pre bought tickets among interested parties, including the venue and artist. The owners of the coordination server may also receive profits from ticket sales as well. A coordination server can also notify fans who purchased pre buy tickets of their successful purchases and send ticket information to the fans, including an electronic ticket, booking number or a physical ticket.

Although specific processes for booking live shows using a coordination server are discussed above, live shows can be booked in any manner as appropriate to the requirements of a specific application in accordance with embodiments of the invention. Processes for booking of live shows from the perspective of a fan in accordance with embodiments of the invention are discussed further below.

### Booking Process for Fans

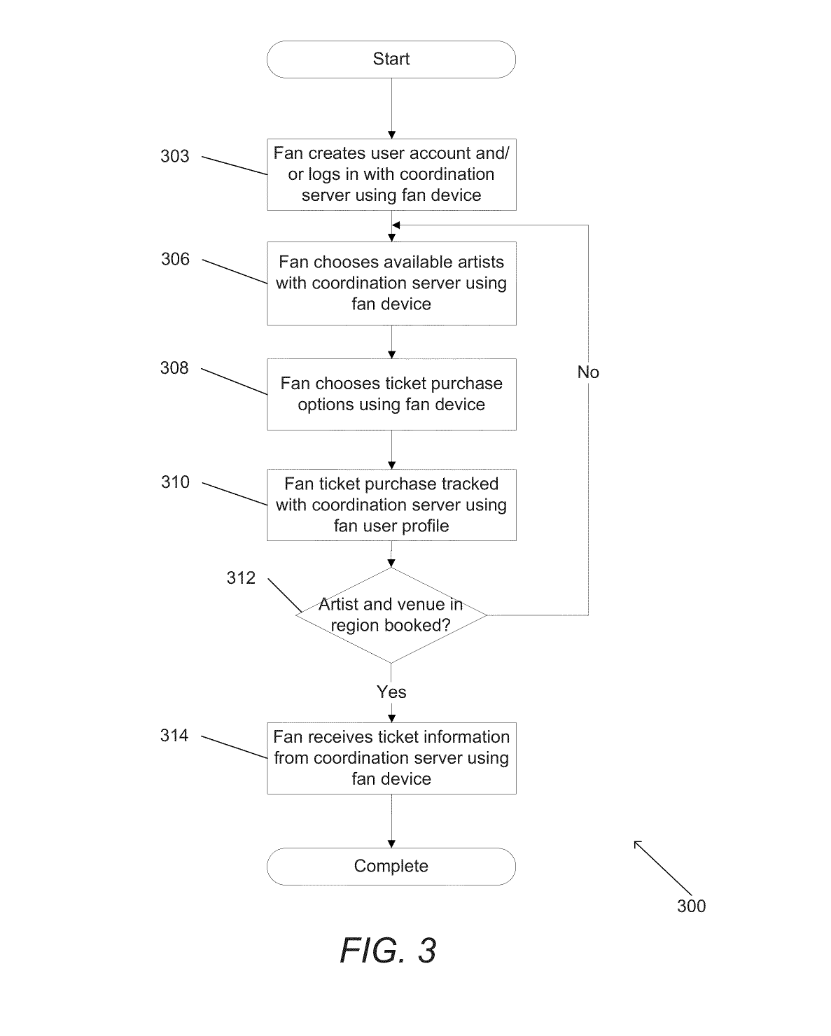

Coordination servers in accordance with several embodiments of the invention can coordinate booking of live shows based upon fans pre buying tickets. A flow chart illustrating a process 300 for a fan receiving ticket information based upon purchasing pre buy tickets using a fan device in accordance with an embodiment of the invention is illustrated in FIG. 3. The process 300 includes a fan creating a user account and/or logging in (303) with the coordination server using a fan device. After logging in (303), the fan chooses (306) available artists with the coordination server using a fan device. After choosing (306) at least one artist, the fan chooses (308) ticket purchase options of the ticket using a fan device. After choosing (308) the ticket purchase options, the fan ticket purchase is tracked (310) with the coordination server using a fan user profile. After tracking (310) is initiated, a decision (312) is made as to whether the artist and venue in a region are booked in accordance with the ticket purchase. If an artist and venue is not booked, the process loops back to the fan choosing (306) available artists and ticket purchase options with the coordination server using a fan device. If an artist and venue is booked, then the fan receives (314) ticket information from the coordination server using a fan device. After receiving (314) the ticket information, the process 300 is complete.

In many embodiments, a fan creates a user account and/or logs in with a coordination server using a fan device. A fan can register with a coordination server in order to open and login in order to manipulate an account in a coordination database. If a fan already has a user account, then the fan can simply login. If a fan does not already have a user account, the fan can create a user account and then log in. Fan accounts can be associated with a particular fan or associated with a group of fans pooling their identities or purchase power into an account.

In various embodiments, a fan chooses available artists with a coordination server using a fan device. In certain embodiments, an artist first indicates that they can be chosen with a coordination server before a fan can choose an artist to play in the fan's chosen region. In particular embodiments, a fan can choose an artist despite an artist not registering and allowing a fan to choose the artist for pre buy tickets.

In several embodiments, a fan can choose ticket purchase options using a fan device. Ticket options can include options such as choosing tickets in a predetermined range of prices or values, such as premium tickets or VIP tickets, and regular tickets. Options for purchasing tickets can also include bidding on a ticket price or stating an amount that the fan is willing to pay for a ticket or tickets. Ticket options can also include details including prices, dates, and specific regions or venue locations.

In a number of embodiments, a ticket purchase made via a user device is tracked with a coordination server using a fan user profile. A fan user profile can include an account associated with the fan in a coordination database. A fan user profile can be modified or personalized by a fan, such as by including personal pictures, indications of preferences or taste in artist or by forming a network of other associated user profiles in the coordination database or elsewhere on a network, such as the Internet. Fans can facilitate exchanges and communications with the artist, other fans, venues or other entities through their user profile. Fan user profiles can also manage and accumulate points which can be redeemed for rewards, thereby incentivizing fans to perform certain actions, such as promoting an artist or venue or purchase of tickets.

In many embodiments, a decision is made as to whether an artist and venue is booked. This decision can be contingent on factors, including the outcome of venue bidding, satisfaction of artist standards for playing in a region, and artist selection of bidding venues. In certain embodiments, a fan has no other input other than the purchase of pre buy tickets. In various embodiments, a fan can influence whether an artist and venue in a region is booked by demonstrations of fan enthusiasm including encouraging others to purchase tickets or convincing artists and venues to come together and book a live show.

In several embodiments, a fan can receive ticket information from a coordination server using a fan device. Once a fan pre buys a ticket and an artist commits to playing in a venue in the region of a fan's pre buy ticket, the coordination server issues a ticket or information that can be used to obtain a ticket based on the pre buy ticket (assuming all of the conditions of the pre buy ticket are satisfied).

Although specific processes for booking live shows from the perspective of a fan are discussed above, live shows can be booked in any manner as appropriate to the requirements of a specific application in accordance with embodiments of the invention. Processes for booking of live shows from the perspective of an artist in accordance with embodiments of the invention are discussed further below.

### Booking Process for Artists

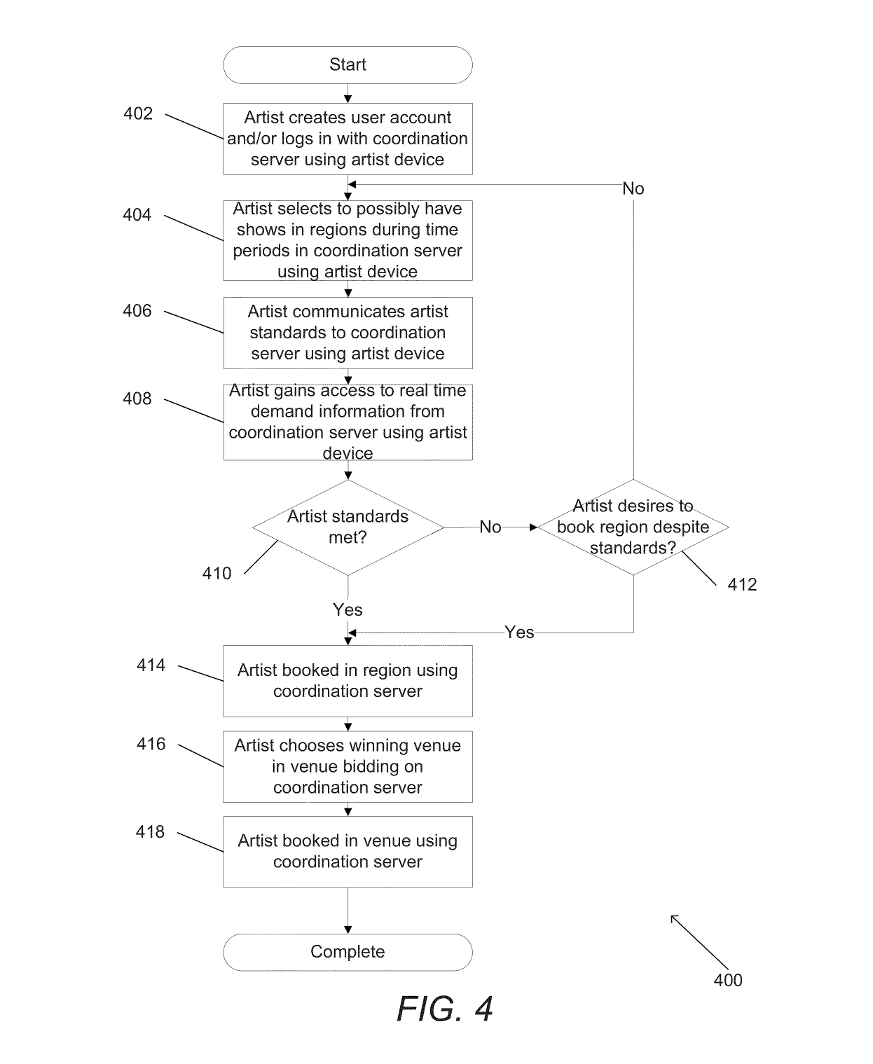

Coordinated server systems in accordance with a number of embodiments of the invention can coordinate booking of live shows by artists based upon standards for performing specified by the artists. A flow chart illustrating a process 400 for an artist booking a live show from artist standards and the artist's choice of bidding venues using an artist device in accordance with an embodiment of the invention is illustrated in FIG. 4. The process 400 includes an artist creating a user account and/or logging in (402) with a coordination server using an artist device. After logging in (402), the artist can communicate (404) information concerning acceptable regions and time periods for performing shows to a coordination server using an artist device. After opening (404) the possibility of having shows, an artist communicates (406) standards for the artist to perform a show in a region to a coordination device using an artist device. The artist can gain access (408) to real time demand information from the coordination server using an artist device. Based upon the real time demand information, a decision (410) can be made by the coordination server concerning whether the artist standards are met. If an artist's standards are not met, then another decision (412) is made by the coordination server as to whether the artist desires to book in a region despite the artist's standards. If the artist's standards are met, then the artist is booked (414) in the region in which the artist standards are met. If the artist does not decide to book, then the process can loop back to the artist selecting (404) to possibly have shows. If the artist desires to book in a region despite the artist standards, then the artist is booked (414) in the region using the coordination server. After the artist is booked (414) in a region, the artist chooses (416) a winning venue in venue bidding on the coordination server. After choosing (416) the winning venue, the artist is booked (418) by the venue using the coordination server. After the artist is booked, the process 400 is complete.

In many embodiments, an artist creates a user account and/or logs in to a coordination server using an artist device. If an artist already has a user account, then the artist can simply login. If an artist does not already have a user account, the artist can create a user account and then log in. Artist accounts can be associated with a particular artist, an agent or manager of the artist, or associated with a group of artists pooling their identities into an account. In certain embodiments, types of artists or associations of artists can create an account.

In several embodiments, an artist can select to offer shows in a region during a certain time period with a coordination server using an artist device. An artist can register and indicate an interest in performing, should the artist standards be met. However, in certain embodiments, an artist does not need to give permission or select to possibly offer shows as fans can request an artist directly. An artist can also indicate a time period that an artist is interested in performing, such as for the next three months, or for the time period of a possible performance or the type of performance the artist is interested in.

In various embodiments, an artist can communicate artist standards to a coordination server using an artist device. An artist can modify a user account in the coordination database indicating what standards the artist wants to establish and the metric by which to judge the standards. A coordination server can analyze the coordination database to determine whether the artist standards are met. Artist standards can span a number of criteria for an artist to commit to play in a region, including price and quantity of pre buy tickets, or can be a single criterion.

In numerous embodiments, an artist gains access to real time demand information from a coordination server using an artist device. Real time demand information can include a coordination server's analysis of data within a coordination database concerning fan demand for an artist, including quantity and type of pre buy tickets, available venues in a region and the capabilities of the venues, or even real world information pulled from other sources including currently popular artists based upon radio or television broadcasts or historical sales of artist performances or products. An artist can gain access by being able to login to an artist account associated with the artist to receive data on real time demand information or having the demand information sent to an artist, such as via email or as a physical report.

In several embodiments, a determination is made as to whether an artist's standards are met. An artist's standards are met when the criteria that an artist sets or elects for an artist to perform are satisfied. These standards can be elected from a set list of criteria, such as options to check off, or communicated to the coordination server. The interplay between the standards or criteria, including combinations of standards or criteria that would be acceptable for satisfaction of the artist standards can be preprogrammed for artist selection or be open for the artist to define. In certain embodiments, artist standards are publicly disclosed. In particular embodiments, artist standards are private or subject to certain privacy setting for disclosure only to certain individuals or groups.

In various embodiments, an artist may desire to book in a region despite the standard. Stated another way, an artist can reserve the right to traverse the standard and book a show despite the non satisfaction of artist standards. This can take place for reasons including that the real time demand information has changed the artist's impression of the artist standards or that the artist may choose to otherwise not abide by standards at all.

In many embodiments, an artist is booked in a region using a coordination server. An artist can agree to perform if an artist's standards are met. Likewise, once an artist is booked, the artist commits to perform in a region and a coordination server notates that commitment in the artist user profile in the coordination database.

In several embodiments, an artist chooses a winning venue in venue bidding on the coordination server. Once an artist is committed to a region, venues can bid or present offers to have an artist perform at their venue. An artist can choose the venue that the artist wants to play in among the bidding venues that satisfy artist standards. In certain embodiments, if there are no venues that satisfy artist standards, then the artist standards are not met and bidding never occurs. In various embodiments, other criteria are used to choose winning bidding venues, including a preprogrammed algorithm that picks venues, fans picking the venue, or a third party picking the venue.

In various embodiments, an artist is booked in a venue using a coordination server. Once an artist is booked in a venue, the coordination server can allocate the proceeds from pre buy tickets or future revenue or assets among interested parties, including the artist, venue, fans or operator of the coordination server.

Although specific processes for booking live shows from the perspective of an artist are discussed above, live shows can be booked in any manner as appropriate to the requirements of a specific application in accordance with embodiments of the invention. Processes for booking of live shows from the perspective of a venue in accordance with embodiments of the invention are discussed further below.

### Booking Process for Venues

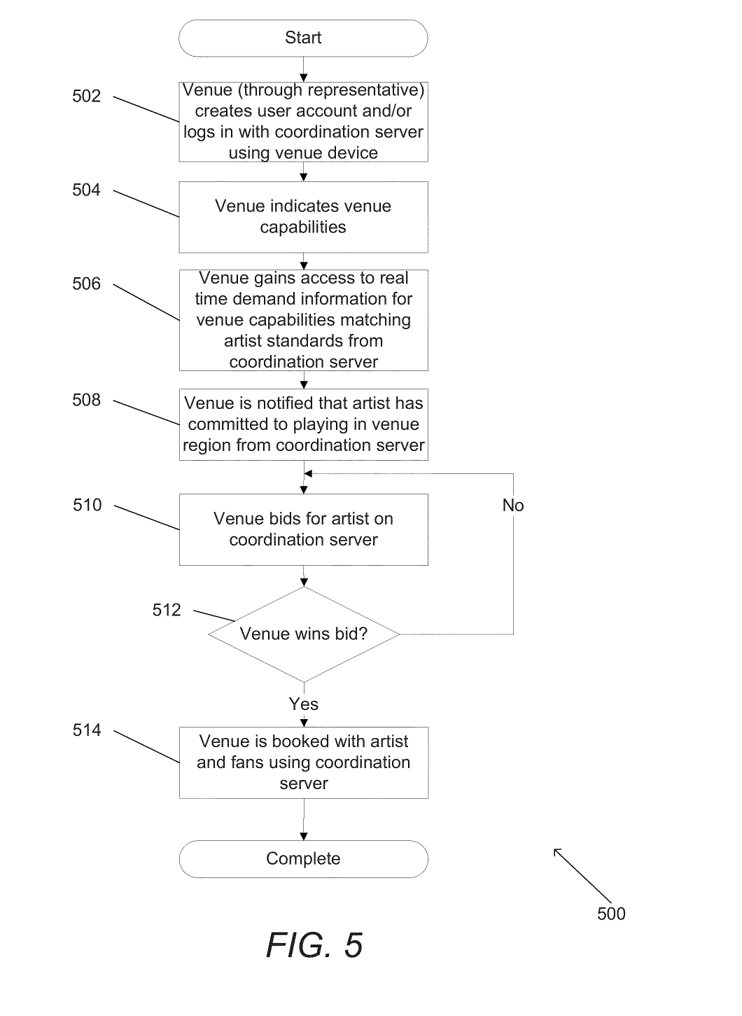

Coordinated servers in accordance with many embodiments of the invention can coordinate the booking of live shows at specific venues based upon the venue capabilities. A flow chart illustrating a process 500 for a venue owner booking a live show at a venue based on venue capabilities and bidding in accordance with an embodiment of the invention is illustrated in FIG. 5. The process 500 includes a venue, through a venue representative, creating a user account and/or logging in (502) with a coordination server using a venue device. After logging in (502), a venue indicates (504) venue capabilities of the venue. After indicating (504) venue capabilities, the venue gains access (506) to real time demand information from artists to book shows at venues having venue capabilities matching those provided to the coordination server. After gaining access (506) to real time demand information, a venue is notified (508) that an artist has committed to playing in a venue's region form the coordination server. After the venue is notified (508) that the artist has committed to play in a venue region, the venue can bid (510) for an artist on the coordination server using a venue device. After bidding (510) is initiated, a decision (512) is made as to whether the venue has won the bidding process. If the venue has not won the bidding process, then the process loops back to the venue bidding (510) for an artist on the coordination server, such as by modifying the bid. If the venue wins the bid, then a venue is booked (514) with an artist using a coordination server. The booking process can involve issuing tickets to all fans that have purchased pre buy tickets. After a venue has booked (514) an artist, the process 500 is complete.

In many embodiments, a venue (through a venue representative) can create a user account and/or log in with a coordination server using a venue device. A venue representative can include anyone who has the authority to represent the venue, such as a venue owner. If a venue already has a user account, then the venue can simply login. If a venue does not already have a user account, the venue can create a user account and then log in. In certain embodiments, types of venues or associations of venues can create an account, such as a brand of coffee shops or a coffee shop association.

In several embodiments, a venue can indicate venue capabilities. Venue capabilities can include aspects of a venue such as a venue's capacity, ticket price ranges, ability to serve alcoholic beverages or food, outdoor or indoor or other aspects of a venue. In certain embodiments, a venue can modify venue capabilities after the venue capabilities are made while others do not allow modification of venue capabilities once they are set.

In various embodiments, a venue gains access to real time demand information from artists looking to book venues capabilities with capabilities matching specified artist standards. Real time demand information can include available artists that have standards that match the venue's capabilities or all artists that can be booked. Real time demand information can include information concerning fans such as the amount of fan pre buy tickets purchased, fan activity in a region or associated with an artist. Real time demand information can also include information about other venues or contain information pulled from other sources such as reviews of artists or trends in an art scene.

In numerous embodiments, a venue is notified that an artist has committed to play in a venue region from a coordination server. In certain embodiments, a venue is not notified that an artist has committed to play in a region and bidding automatically begins.

In a variety of embodiments, venues bid for an artist or artists to play at their venue over a coordination server. Bidding can be regulated, including by dictating the number of bids that may be made in a certain time period, or the communication that a venue can make with artists or fans during the bidding process. Bidding is discussed in more detail below.

In a number of embodiments, a decision is made as to whether the venue has won a bid. Winning a bid can come from an automated process where certain criteria is set to determine what a winning bid is or by artist input as to what venue wins the bidding or by other criteria for winning a bid.

In many embodiments, a venue is booked with artists and fans using a coordination server after a winning bid is determined. With the winning bid, essential details of a booked show are known and the coordination processor can book the artist and venue, distribute ticket information to fans and distribute current and future proceeds from the show to interested parties.

Although specific processes for booking live shows from the perspective of a venue are discussed above, live shows can be booked in any manner as appropriate to the requirements of a specific application in accordance with embodiments of the invention. Processes for the bidding process for the booking of live shows in accordance with embodiments of the invention are discussed further below.

### Bidding Process

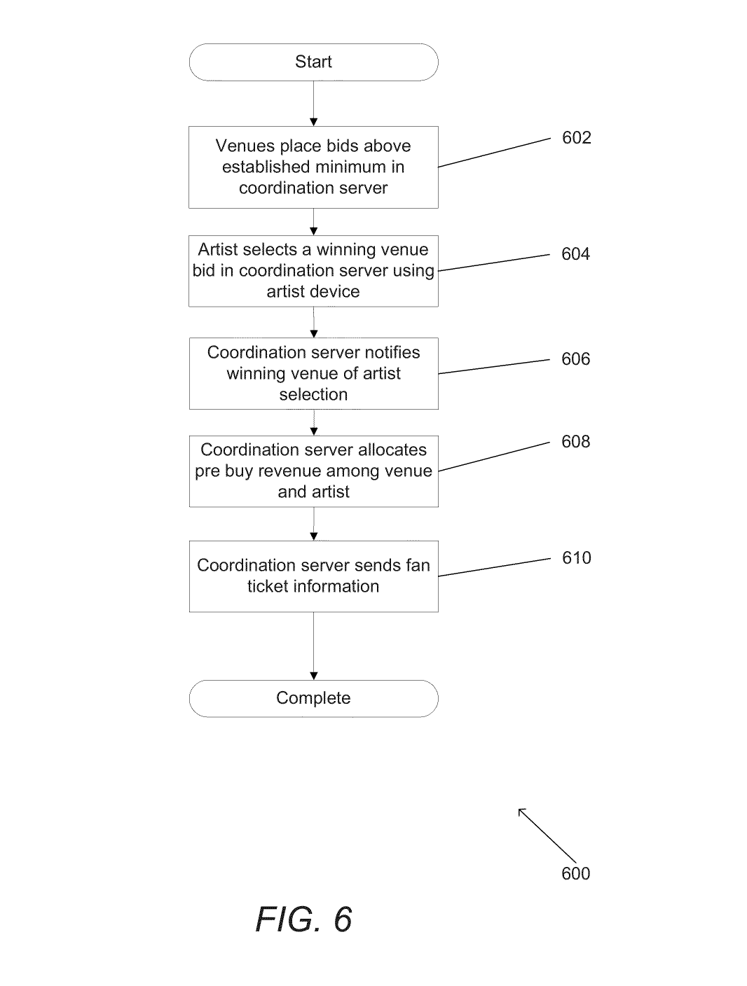

Coordination servers in accordance with several embodiments of the invention can coordinate bidding processes for booking shows that select a winning venue from bidding venues. A flow chart illustrating a process 600 for bidding and coordinating a successfully booked show using a coordination server in accordance with an embodiment of the invention is illustrated in FIG. 6. The process 600 includes venues placing bids (602) above an established minimum in a coordination server. After venues place bids (602), an artist can select (604) a winning venue bid in the coordination server using an artist device. After selection (604) of a winning venue, the coordination server notifies (606) the winning venue of the artist selection. After notification (606) of artist selection, the coordination server allocates (608) pre buy profits among the venue and artist. After allocating (608) revenue, the coordination server sends (610) fans that pre bought tickets their ticket information. After sending (610) ticket information, the process 600 is complete.

In many embodiments, venues place bids above an established minimum on a coordination server. An established minimum can be preprogrammed on a coordination server or established by the artists, fans, collection of venues or a third party. Certain embodiments do not have an established minimum and venues are free to bid with whatever they choose. In various embodiments, bids can be of any value including monetary value, concessions that a venue is willing to give bands such as booking out the entire venue, or even that they are only interested in booking the artist.

In several embodiments, artists select a winning venue bid with a coordination server using an artist device. In certain embodiments, selection of winning bids can be made by the artist that is being booked or another party, such as automatic selection by criteria set in the coordination server or fans.

In various embodiments, a coordination server notifies a winning venue of artist selection. This notification can be given as congratulations or may give other information as well, such as a receipt of the transaction. In certain embodiments, no notification is given.

In numerous embodiments, a coordination server can allocate pre buy profits among the venue and artist. A coordination server can distribute the proceeds from booking the show to interested parties. The distribution can be the result of prior negotiation between the interested parties.

In a number of embodiments, a coordination server can send fans ticket information. Ticket information can be the actual ticket, including a paper or E-ticket, or can also be information relating to access to a show, including instructions on receiving a ticket or instructions on how to access a show.

Although specific processes for bidding in booking live shows are discussed above, live shows can be booked in any manner as appropriate to the requirements of a specific application in accordance with embodiments of the invention. User interfaces suitable for use during the booking of live shows in accordance with embodiments of the invention are discussed further below.

### User Interfaces

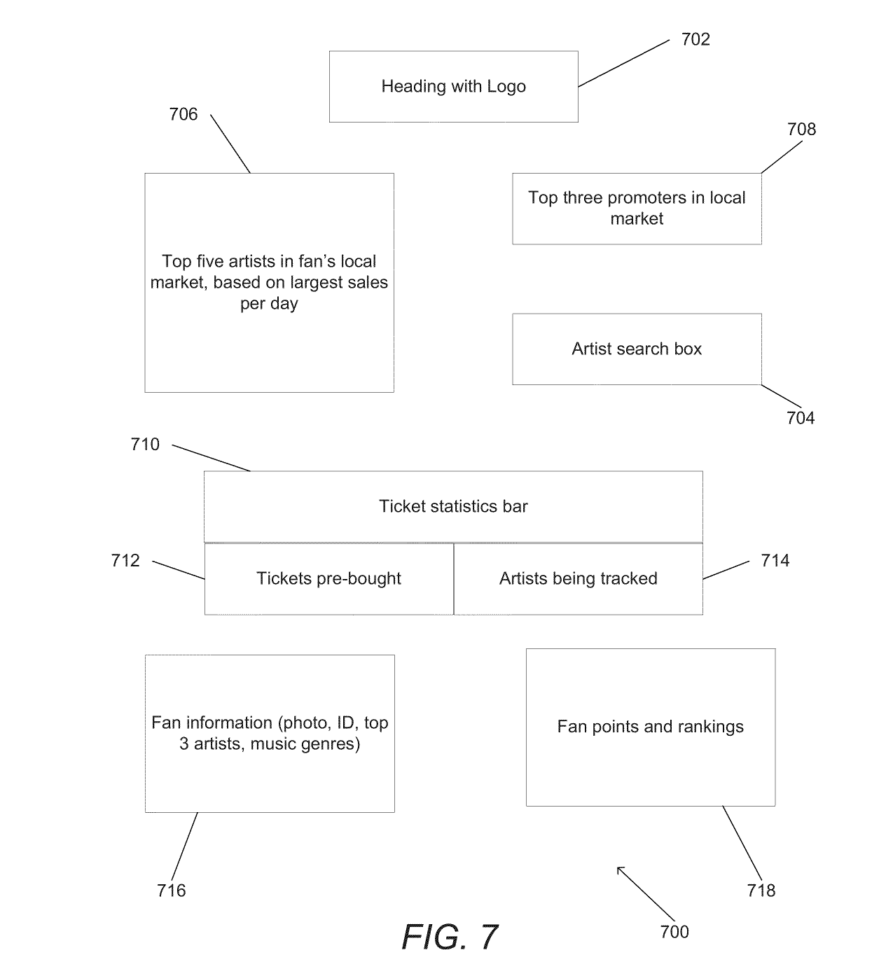

User interfaces can be used for coordinated booking of live shows that are intuitive and present information that is of interest to the user in accordance with embodiments of the invention. A home screen user interface 700 on a fan device in accordance with an embodiment of the invention is illustrated in FIG. 7. The home screen user interface 700 includes a heading with a logo 702 and an artist search box 704. The user interface can also include information of interest including top five artists in a fan's local market 706 and top three fans, who influence other fans in a local market 708. In other embodiments, any of a variety of information of interest appropriate to the requirements of a specific application can be displayed via the user interface. The user interface can also include a tickets statistics bar 710, including the number of tickets pre bought 712 and artists that are being tracked 714. A user interface can also include information more personal to a fan including fan information 716, such as a personal photo, personal information, top three artists and artistic interests, as well as fan points and rankings 718.

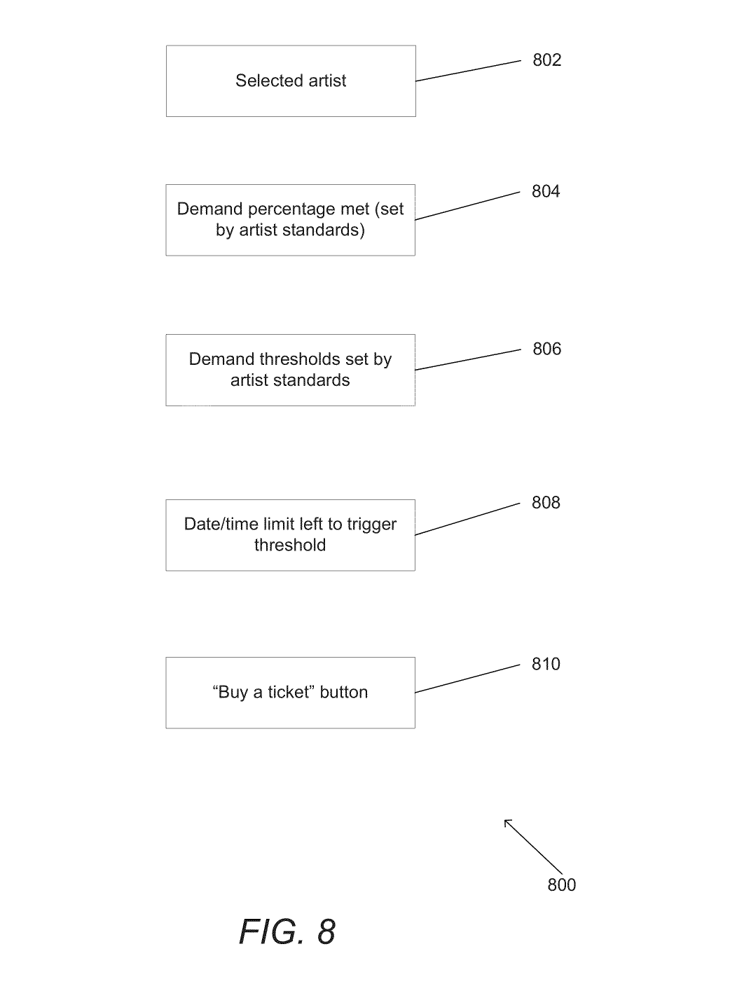

A fan's user interface 800 for a selected artist on a fan device in accordance with an embodiment of the invention is illustrated in FIG. 8. The user interface 800 can include a selected artist 802, the percentage of demand specified in the artists standards already met for the artist 804, demand thresholds that enumerate artist standards 806, the date or time limit left to trigger the threshold 808 and a “buy a ticket” button 810.

In many embodiments, user interfaces are on a user device, including a fan device, artist device or a venue device. These devices allow for a user of the device to access a coordination server or manage data in a coordination database. A user interface allows for ease of access on a user device, illustrating the information that is of interest to the user. In certain embodiments, a user device can utilize programs or applications such as a web browser that can access data of interest formatted as a user interface. Although the descriptions and figures illustrate specific embodiments of user interfaces, there can be many other user interfaces for users including fans, artists and venues and operators of the coordination server in accordance with many embodiments of the invention.

Although specific user interfaces for booking live shows are discussed above, live shows can be booked in any manner as appropriate to the requirements of a specific application in accordance with embodiments of the invention. Manners in which advertisers may be involved during the booking of live shows in accordance with embodiments of the invention are discussed further below.

### Advertising

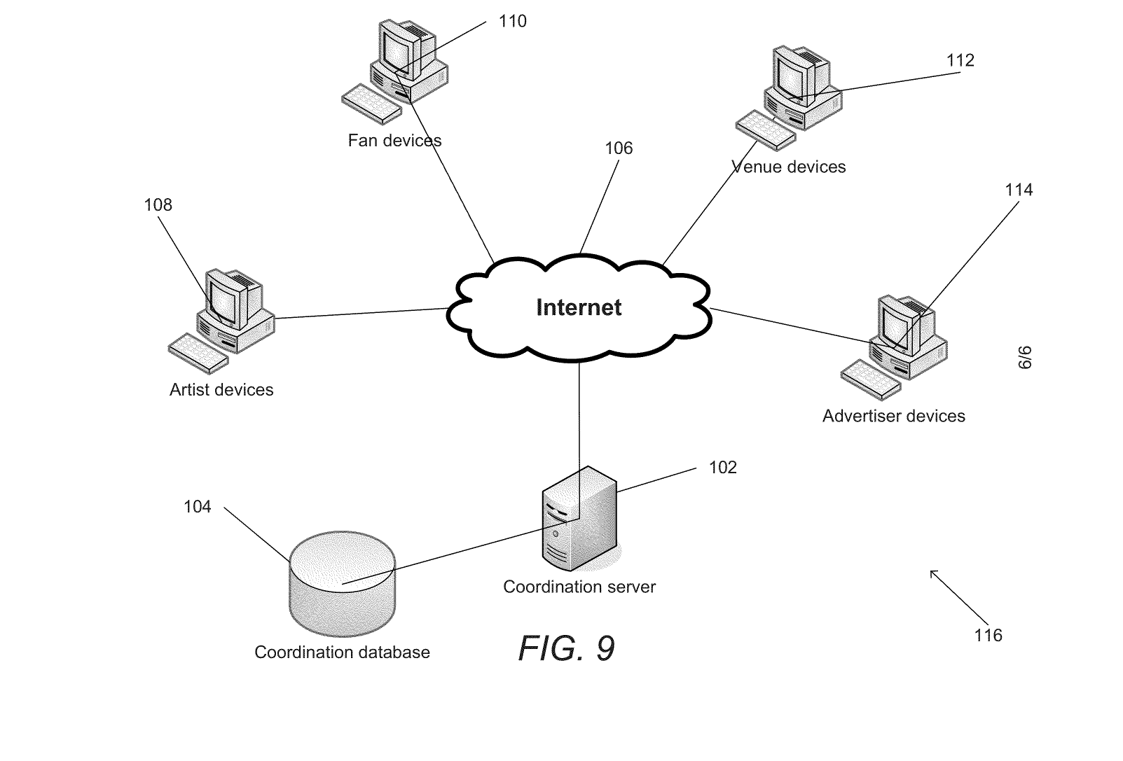

Advertisers typically pay fees to bands and concert promoters to be associated with live shows and tours. Music fans who attend live shows are receptive to advertisers that help them see their favorite acts. National tours featuring significant, or “A-list”, artists are routinely presented by large advertisers. Advertisers can seek associations with certain types of music and particular artists as an effective way to reach their core demographic consumers. A system that enables advertisers, which are capable of influencing the purchasing power of fans, to meet artist standards for performing in a geographic location in accordance with an embodiment of the invention is illustrated in FIG. 9. Similar to above described embodiments, the system 116 can include artist devices 108, fan devices 110 and venue devices 112 that are connected to a coordination server 102 over the Internet 106. The coordination server 102 is also connected to a coordination database 104 and manages, manipulates and analyzes the data within the coordination database. In the illustrated embodiment, an advertiser device 114 is also connected with the coordination server 102 over the Internet 106 and can influence the interactions between the artists, fans and venues through their respective devices. In certain embodiments, an advertiser using an advertiser device can pre buy tickets, lowering the threshold required for fans to pre buy tickets for an artist to commit to performing in a geographic location. Likewise, advertisers can strike deals with an artist to perform at a certain venue or to strike a deal with a venue that makes the venue more attractive to an artist, such as offering to remodel a venue or to financially support a venue so that the venue's bid for the artist's performance is more competitive. Also, artists, fans and venues can each set qualifications for the type of advertiser that is able to interact with them. For example, the advertisers allowed to participate can be limited by the identity of the advertiser, such as only allowing certain handpicked advertisers to participate in the process, or by the type of the advertiser, such as only allowing advertisers that are associated with certain industries to participate.

In many embodiments, advertisers are able to reach fans (matching the advertiser's core consumer demographic) at targeted local and national levels which will also provide flexibility for artists and venues to choose the particular advertiser associated with their shows. Thereby, advertisers, artists and venues will have direct contact with each other. Advertisers are able to gain unprecedented access to endorse artist shows or align directly with music venues. Artists and venues will receive consideration from advertisers to sponsor their show(s) and will gain the ability to choose the advertisements, such as brand names or slogans that they want to associate with, from their chosen advertiser for their show or venue before or after each booking is finalized. There are many ways in which an advertiser can participate in interactions between fans, artists and venues in accordance with many embodiments of the invention, including within a local advertising model or a branding model as discussed below.

In various embodiments, a local advertising model allows for advertisers to supplement fan demand by purchasing a number of pre buy tickets, lowering the bar necessary for an artist to play in a particular geographic location for fans purchasing pre buy tickets. In particular embodiments, advertisers are given the opportunity to pay a fee to pre buy tickets or to even purchase all of the tickets necessary for an artist's threshold to be met for distribution to consumers who view their ads. The ads may be presented to the fans via the coordination server, directly by the advertiser or by a third party. Advertisers can also bring artists to play in geographic location when the artist standards for that geographic location are not yet met. Advertisers can also be given access to real-time data for various artists' pre buy ticket sales for their local market. In certain embodiments, only qualified advertisers are allowed to pre buy tickets. These qualified advertisers can be defined by the requirements set by an artist for the type of advertiser or particular advertiser(s) an artist is willing to associate with. In effect, the fee paid by the local advertiser will help pre buy ticket sales reach the artist standards that allow the artist to commence venue bidding. If the show is ultimately booked, the advertiser can receive placement for show tickets based upon the pre buy tickets purchased by the advertiser. These tickets can be distributed to the fans from the advertiser. In certain embodiments, these tickets are distributed on a first come and limited basis, such as where the 100 fans who view a particular advertisement by the advertiser can receive the free ticket. Advertisers have a chance to advertise their business and brand in front of fans who receive a free ticket to a live show, organically building fan loyalty to the artist while also supporting performances at venues.

In numerous embodiments, a branding model is utilized where advertisers can deal directly with a venue or an artist for the artist to play in a particular geographic location or venue. In certain embodiments, only qualifying advertisers will gain access to actively participate in the booking of an artist at a particular venue. Advertisers can be qualified based on a number of factors set by the fans, artists, venues or the coordination server, including the amount of pre buy tickets the advertiser purchased, the identity of the advertiser (such as an advertiser that is specifically qualified by the artist, fans or venue), the type of advertiser (such as the reputation of an advertiser or the type of products or services associated with the advertiser). In particular embodiments, these qualifying advertisers are given the opportunity to be directly associated with an artist's performance at a venue as a “presenting sponsor” of a show, or by partnering with the artist or venue by paying some consideration to either the artist or venue or both. This would allow artists to gain more revenue from a show or series of shows. This would also allow venues to earn extra revenue to help pay a higher guaranteed payment to an artist to win the booking of the artist at their venue. In certain embodiments, tickets and promotions for a show can feature the advertiser's name and branding as well as branding at the actual show. In particular embodiments, qualifying advertisers have access to only general details of artist and venues in the booking process between artists, fans and venues. Advertisers may place offers before or after an actual booking is made between the artist and venue.

In many embodiments, an advertiser's offer is one additional factor to consider for an artist in which venue to choose (some advertisers may link their offer to a particular venue while others may not). Additionally, the advertiser's offer is one additional factor to consider for the venue and may help the venue offer a higher bid to the artist to secure the booking or provide the venue with in-kind product to generate extra revenue at the show.

Although processes for advertiser involvement in booking live shows are discussed above, live shows can be booked in any manner as appropriate to the requirements of a specific application in accordance with embodiments of the invention.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What Is claimed:

1. A system for booking live shows, comprising:
a coordination database configured to store at least one artist account, at least one fan account and at least one venue account; and
a coordination server in communication with the coordination database configured to:
query at least one artist account for standards that an artist associated with the artist account requires for performance;
query at least one fan account for pre buy tickets, wherein a pre buy ticket indicates that a certain amount of funds have been allocated for charge for the purchase of a ticket to experience a performance by the artist after the artist is booked at a venue;
determine whether the standards are met based upon the amount of funds allocated by pre buy tickets;
query at least one venue account for bids by venues after the standards are met, wherein a bid is an offer by a venue for the artist to perform at the venue; and
book the artist at a winning venue, wherein the winning venue is a venue whose offer is accepted.

2. The system of claim 1, wherein the pre buy tickets are associated with a geographical location for a performance by the artist.

3. The system of claim 1, wherein the standards include an artist's preference for geographic location for performance by the artist.

4. The system of claim 1, wherein the standards include a time period for standards to be met within.

5. The system of claim 1, wherein the standards can be modified to be immediately satisfied.

6. The system of claim 1, wherein the coordination server is configured to query venue accounts within a geographical location that meets the standards.

7. The system of claim 1, wherein the coordination database is configured to store an advertiser account and the coordination server is configured to query advertiser accounts for pre buy tickets.

8. The system of claim 1, wherein the coordination server is configured to receive the standards from an artist device and store the standards in an artist account.

9. The system of claim 1, wherein the coordination server is configured to receive bids from a venue device and store the bids in a venue account.

10. The system of claim 1, wherein the standards includes at least one criteria selected from the group consisting of geographical location, pre buy ticket quantity and pre buy ticket price range.

11. The system of claim 1, wherein the coordination server distributes pre buy ticket revenue between the artist account and the venue account.

12. The system of claim 1, wherein the coordination server regulates bids by setting at least one criteria by which bids abide selected from the group consisting of frequency of bidding and minimum bidding amount.

13. A method for booking live shows, comprising:
querying at least one artist account stored on a coordination database using a coordination server in communication with the coordination database for standards that an artist requires for performance;
querying at least one fan account stored on the coordination database using the coordination server for pre buy tickets, wherein a pre buy ticket indicates that a certain amount of funds have been allocated for charge for the purchase of a ticket to experience a performance by the artist after the artist is booked at a venue;
determining whether the standards are met based upon the amount of funds allocated by pre buy tickets using the coordination server;
querying at least one venue account using the coordination server for bids by venues after the standards are met, wherein a bid is an offer by a venue for the artist to perform at the venue; and
booking the artist using the coordination server at a winning venue, wherein the winning venue is a venue whose offer is accepted.

14. The method of claim 13, wherein the pre buy tickets are associated with a geographical location for a performance by the artist.

15. The method of claim 13, wherein the standards include an artist's preference for geographic location for performance by the artist.

16. The method of claim 13, wherein the standards include a time period for standards to be met within.

17. The method of claim 13, wherein the standards can be modified to be immediately satisfied.

18. The method of claim 13, wherein the coordination server is configured to query venue accounts within a geographical location that meets the standards.

19. The method of claim 13, comprising:
querying an advertiser account for pre buy tickets, wherein the coordination database is configured to store the advertiser account.

20. The method of claim 13, wherein the standards includes at least one criteria selected from the group consisting of geographical location, pre buy ticket quantity and pre buy ticket price range.
